(19) United States
(12) Patent Application Publication
(10) Pub. No.: US 2026/0217745 A1
(43) Pub. Date: Jul. 30, 2026

(54) METHOD FOR PREPARING A NEODYMIUM ALKYL PHOSPHATE SOLUTION

(71) Applicants: UMICORE SPECIALTY MATERIALS BRUGGE NV, Brugge (BE); SYNTHOS PBR S. R. O., Kralupy Nad Vltavou (CZ)

(72) Inventors: Maria SIOLEK-KOMOREK, Chorzów (PL); Radoslaw KOZAK, Chorzów (PL); Jaroslaw ROGOZA, Kryspinów (PL); Garrett MINNE, Bissegem (BE); Matthias MOENS, Ursel (BE)

(21) Appl. No.: 19/145,612

(22) PCT Filed: Dec. 22, 2023
(86) PCT No.: PCT/EP2023/087697

§ 371 Date: Jul. 3, 2025

(30) Foreign Application Priority Data
Jan. 4, 2023 (EP) 23150250.1

(51) Int. Cl. C07F 9/11; C08F 36/02

(52) U.S. Cl. CPC C07F 9/11; C08F 36/02

(57) ABSTRACT

The present invention relates to a method for producing a neodymium (III) alkyl phosphate solution, said method comprising the steps of: (a) reacting neodymium (III) compound with an organophosphorous acid in a solvent in the presence of a promoter thereby obtaining a neodymium (III) alkyl phosphate solution; (b) adding an anti-gelling agent to the neodymium (III) alkyl phosphate solution obtained in step (a); and (c) removing water formed and/or added during step (a) from the obtained neodymium (III) alkyl phosphate solution, thereby obtaining a solution comprising neodymium (III) alkyl phosphate. The invention relates also to a neodymium (III) alkyl phosphate solution obtained by the above-described method as well as use of this solution as a catalyst precursor for diene polymerization.

### FIELD OF THE INVENTION

The invention relates to a method for preparing a neodymium alkyl phosphate solution in a non-polar organic solvent. Solutions obtainable by the claimed method are useful in particular as starting materials for the preparation of catalysts for diene polymerization.

### BACKGROUND ART

Neodymium complexes, including alkyl phosphates are well known catalysts for cis-1,4 polymerization of conjugated dienes, including in particular 1,3-butadiene homopolymerization.

U.S. Pat. No. 6,197,713 B1 describes a process for preparing a gel-free hydrocarbon solution containing a lanthanide rare earth series compound by dissolving or synthesizing a lanthanide compound in an inert hydrocarbon solvent with a Lewis acid selected from the group consisting of a transition metal halide, an organometallic halide whose metal is of group 2, 12, 13 and 14 of the Periodic System, and a halide of an element of group 2, 12, 13, 14 and 15 of the Periodic System in an amount sufficient to prevent formation of highly viscous solutions. Hydrocarbon soluble Lewis acids are the most preferred, such as tin (IV) tetrachloride.

U.S. Pat. No. 8,404,821 B2 discloses a method for preparing a solution of a rare-earth organophosphate in an organic solvent, comprising reacting a rare-earth compound selected from the group consisting of oxides, hydroxides, carbonates and hydroxycarbonates of a rare earth metal with an organophosphorus acid and in the presence of the solvent. The reaction is carried out in the presence of a compound selected from the group consisting of nitric acid, hydrochloric acid, acetic acid, formic acid, propionic acid and the rare-earth salts of said acids. Preferred embodiments of the method include the use of neodymium as a rare earth metal, as well as phosphoric acid diesters and cycloaliphatic solvents. Another embodiment of the method disclosed in U.S. Pat. No. 8,404,821 B2 covers the use of water used in the molar ratio to the rare-earth metal being at least 25, preferably at least 50.

U.S. Pat. No. 7,906,631 B2 discloses a method of producing a rare earth salt of a dialkyl phosphate, wherein a rare earth oxide or a rare earth hydroxide is reacted with a dialkyl phosphate having a purity of not less than 97% in a non-polar solvent in the presence of at least one compound selected from a halogenated hydroacid, phosphorous acid and a rare earth halide as a catalyst. Preferred embodiments of the method include the use of neodymium as a rare earth metal, as well as bis(2-ethylhexyl)phosphate and hydrochloric acid. Among preferred viscosity-reducing agents tin (IV) tetrachloride was explicitly mentioned.

Rare-earth metal alkyl phosphate solutions, including in particular neodymium alkyl phosphate solutions obtained in the prior art methods show high viscosity. This feature as least partially results from gel formation in the reaction of rare-earth metal precursor with an organophosphorous compound. Such high viscosity has to be reduced by adding an alcohol, a carboxylic acid or a phosphoric acid, before being used for preparing catalyst systems for diene polymerization. However, as such additional additives constitute undesired impurities in the final rubber product, there is a need for providing neodymium alkyl phosphate solutions having viscosity at acceptable levels.

In another approach, U.S. Pat. No. 9,090,637 B2 applies high shear rates in a process for the synthesis of a rare-earth organophosphate solutions resulting in a product free from residual rare-earth precursor and having consistency suitable for processing with equipment suitable for low-viscosity products. This process comprises dispersing, under shear rates of greater than 200 s⁻¹, of a rare-earth oxide in a two-phase medium comprising at least one organic solvent, water, an organophosphorous acid and a small amount of organic or mineral acid and, simultaneously or sequentially, reacting the rare-earth oxide with the organophosphorous acid and the small amount of organic or mineral acid. The expression “high shear dispersion” in U.S. Pat. No. 9,090,637 B2 means a dispersion carried out with stirring at high blade tip peripheral speeds of greater than 4 m/s.

However, there is still a need for a method of preparing a neodymium alkyl phosphate solution in an organic solvent showing low viscosity combined with high neodymium content and free of residual rare-earth precursors or any other impurities in amounts being detrimental to any subsequent use. Ideally such method includes a gentle mixing which requires less energy input and no investment in additional reactor equipment for industrial scale. In particular, there is a constant need for providing neodymium (III) alkyl phosphate solutions free of substances negatively affecting the environment and/or the activity of target catalyst systems such as tin (IV) tetrachloride used in U.S. Pat. No. 6,197,713 B1 and U.S. Pat. No. 7,906,631 B2 as a viscosity reducing agent. Further, there is a need for providing a method for preparing a neodymium alkyl phosphate solution in an organic solvent suitable for producing a precursor of a highly active catalyst systems for cis-1,4 polymerization of conjugated dienes. Yet further, there is a need for providing a method for preparing a neodymium alkyl phosphate solution in an organic solvent allowing to effectively prevent or a least significantly limit gel formation.

### SUMMARY OF THE INVENTION

Aim of the present invention was to solve one or more of the above-identified problems and/or satisfy one or more of the above-identified needs. Surprisingly it has been found that addition of an anti-gelling agent to a gel solution obtained in a reaction of a neodymium (III) precursor that may be selected for instance from neodymium oxide, neodymium hydroxide and hydrates thereof with an organophosphorous acid in a non-polar organic solvent in the presence of a promoter at reflux temperature, allows to obtain a clear low-viscosity solution of neodymium alkyl phosphate suitable for producing a precursor of a highly active catalyst systems for cis-1,4 polymerization of conjugated dienes without applying high shear rates.

In a first aspect, the present invention provides a method for producing a neodymium (III) alkyl phosphate solution said method comprising the steps of:
(a) reacting neodymium (III) compound with an organophosphorous acid in a solvent in the presence of a promoter, thereby obtaining a neodymium (III) alkyl phosphate solution;
(b) adding an anti-gelling agent to the neodymium (III) alkyl phosphate solution obtained in step (a); and
(c) removing water formed and/or added during step (a) from the obtained neodymium (III) alkyl phosphate solution, thereby obtaining a solution comprising neodymium (III) alkyl phosphate.

In the context of the present invention, the term “promoter” refers to any compound capable of promoting or catalyzing the reaction of said neodymium (III) compound with said organophosphorus acid. In a preferred embodiment of the present invention, said promoter is water. In a preferred embodiment of the present invention, said promoter, preferably water, is added during step (a). Preferably, said promoter, preferably water, is added at the onset of the reaction in step (a). Said promoter may be added during step (a) to compensate for the evaporation of at least a part of the water present in the reaction mixture and/or to control the content of said promoter, specifically water, in the reaction mixture. In a preferred embodiment of the present invention, said promoter, preferably water, is removed at least in part after step (a) and/or after step (b). Said promoter, specifically water, may be removed by distillation, preferably azeotropic distillation.

In the context of the present invention, the term “anti-gelling agent” is to be considered as synonymous to the term “gel breaker,” “gel breaking agent” or “gel preventing agent,” and refers to any compound which is capable of reducing the viscosity of a gel matrix formed by neodymium (III) alkyl phosphates in a solution; and/or any compound which is capable of essentially preventing formation of a gel matrix comprising of neodymium (III) alkyl phosphates. Preferably, such anti-gelling agent is capable of reducing the viscosity of the resulting solution below 150 dPa·s. Said anti-gelling agent is added after reaction of said neodymium (III) compound with an organophosphorus acid, i.e. after formation of the neodymium (III) alkyl phosphate in solution. When said anti-gelling agent is a gaseous compound, such as hydrochloric acid, said anti-gelling agent is preferably added at a reduced temperature after completion of the reaction of said neodymium (III) compound with said organophosphorus acid, e.g. by cooling the reaction mixture to a temperature of less than 60° C., preferably less than 50° C., and more preferably less than 40° C. It is not advantageous to cool to a temperature below room temperature, i.e. about 20° C. to 25° C.

The inventive method allows for the preparation of neodymium-based organophosphate compounds in solution via new, alternative gentle mixing processes which are straightforwardly performed in a one-pot procedure at low shear rates. The compounds in solution are easily purified as well, e.g. an additional washing step such as reported for certain prior art procedures may be omitted. Advantageously, methods according to the present invention ascertain that the obtained compounds in solution do not form a gel. Gel formation usually occurs in neodymium (III) alkyl phosphate solutions, presumably due to formation of oligomeric and/or polymeric neodymium (III) complexes. Such gelling renders the obtained solution difficult to handle and difficult to dose when used as a catalyst precursor system for diene polymerization reactions. This, in turn, affects the quality of the obtained diene polymers.

In a preferred embodiment, the present invention provides a method according to the first aspect of the invention, whereby steps (a), (b) and (c) are performed sequentially.

In another preferred embodiment, the present invention provides a method according to the first aspect of the invention, whereby water is removed in step (c) until a neodymium concentration of at least 3 wt. %, relative to the total weight of the neodymium (III) alkyl phosphate solution, is achieved. Preferably water is removed in step (c) until a neodymium concentration of at least 4 wt. % is achieved. More preferably water is removed in step (c) until a neodymium concentration of at least 5 wt. %, or even at least 6 wt. % is achieved.

In a preferred embodiment, the present invention provides a method according to the first aspect of the invention, whereby said neodymium (III) compound is reacted in step (a) with said organophosphorus acid, whereby said organophosphorus acid is provided in a stoichiometric excess, relative to the amount of said neodymium (III) compound. Preferably, said organophosphorus acid is provided in an amount of 3.0 to 3.40 equivalents per equivalent of neodymium (III) compound, and preferably in an amount of 3.00 to 3.34, 3.10 to 3.30, or even 3.15 to 3.25 equivalents organophosphorus acid per equivalent of neodymium (III) compound.

In a preferred embodiment, the present invention provides a method according to the first aspect of the invention, whereby said neodymium (III) compound is selected from the group consisting of neodymium (III) oxide, neodymium (III) hydroxide, neodymium (III) carbonate, and hydrates thereof.

Preferably, said neodymium (III) compound is selected from the group consisting of neodymium oxide, neodymium hydroxide and hydrates thereof, and most preferably said neodymium (III) compound is neodymium oxide, or hydrates thereof. Preferred neodymium (III) compounds provide excellent conversion in the reaction with said organophosphorous acid.

In a preferred embodiment, the present invention provides a method according to the first aspect of the invention, whereby the organophosphorous acid is selected from the group consisting of phosphoric acid diesters of formula (RO)(R′O)PO(OH); phosphoric acid monoesters of formula (RO)P(O)(OH)₂; phosphonates of formula (RO)R′P(O)(OH) or RP(O)(OH)₂; phosphinates R(R′)P(O)OH or R(H)P(O)OH; and mixtures of two or more of the aforementioned, wherein each of R and R′, if present, independently denotes an n-butyl, isobutyl, pentyl, amyl, isopentyl, 2,2-dimethylhexyl, 2-ethylhexyl, 1-ethylhexyl, tolyl, nonylphenoxy radical.

In a preferred embodiment, the present invention provides a method according to the first aspect of the invention, whereby said organophosphorous acid is bis(2-ethylhexyl) hydrogen phosphate. In the context of the present invention, bis(2-ethylhexyl) hydrogen phosphate is abbreviated as DEHPA.

In a preferred embodiment, the present invention provides a method according to the first aspect of the invention, whereby the molar ratio of bis(2-ethylhexyl) hydrogen phosphate to neodymium ranges from 3.00 to 3.40.

In a preferred embodiment, the molar ratio of bis(2-ethylhexyl) hydrogen phosphate to neodymium ranges from 3.00 to 3.34, preferably from 3.10 to 3.30 and more preferably from 3.15 to 3.25. It was found that lower molar ratios of DEPHA to neodymium do not allow for a full conversion of starting materials, whereas higher molar ratios of DEPHA to neodymium tend to be unstable, as observed by a spontaneous phase separation. Most preferably, said molar ratio of DEPHA to neodymium is about 3.16, 3.18, 3.20 or 3.22 or any value there in between.

In a preferred embodiment, the present invention provides a method according to the first aspect of the invention, whereby said solvent is a hydrocarbon solvent. Preferably, said hydrocarbon solvent comprises an aliphatic or cycloaliphatic alkane.

In a preferred embodiment, said aliphatic or cycloaliphatic alkane has 6 to 9 carbon atoms, preferably 6 to 8 carbon atoms and most preferably 7 carbon atoms. In a preferred embodiment, said solvent is selected from the group comprising n-hexane, n-heptane, cyclopentane, cyclohexane, methylcyclohexane, and mixtures thereof. Most preferably, said solvent is methylcyclohexane.

In a preferred embodiment, the present invention provides a method according to the first aspect of the invention, whereby said anti-gelling agent is a non-tin-based anti-gelling agent. In another preferred embodiment, the present invention provides a method according to the first aspect of the invention, whereby said anti-gelling agent comprises one or more compounds selected from the group consisting of:
mineral acids selected from the group consisting of perchloric acid HClO₄, chloric acid HClO₃, chlorous acid HClO₂, hydrochloric acid HCl, bromic acid HBrO₃, hydrobromic acid HBr, iodic acid HIO₃, periodic acid HIO₄, orthoperiodic acid H₅IO₆, hydroiodic acid HI, nitric acid HNO₃, peroxonitric acid HNO₄ and silicic acid H₄SiO₄;
organic acids selected from the group consisting of: trichloroacetic acid CCl₃—COOH), dichloroacetic acid CCl₂H—COOH and trifluoroacetic acid CF₃COOH;
lanthanide halides, lanthanide nitrates, as well as hydrates thereof;
silicon (IV) halides, such as silicon (IV) tetrahalides;
alkyl halides; and
silicon (IV) esters.

In a more preferred embodiment, the present invention provides a method according to the first aspect of the invention, whereby said anti-gelling agent is a non-tin-based anti-gelling agent comprises one or more compounds selected from the group listed above.

All the preferred anti-gelling agents listed above proved to be unharmful for the neodymium (III) alkyl phosphate-based catalyst systems. While they are highly effective in small amounts, they do not interfere with the catalyst system.

In a preferred embodiment, said anti-gelling agent comprises hydrochloric acid. In another preferred embodiment, said anti-gelling agent comprises a lanthanide halide, preferably a neodymium (III) chloride or a hydrate thereof. In another preferred embodiment, said anti-gelling agent comprises a silicon (IV) halide of general formula RₘHₙSiXₚ, wherein X is a halide selected from Cl, Br, I, and wherein X is preferably Cl, wherein p is an integer from 1 to 4, wherein m and n, independently from one another, denote an integer from 0 to 3, and wherein m+n+p=4. Preferred silicon (IV) halides are dichlorodimethylsilane, chlorodimethylsilane and silicon tetrachloride. In an alternative or complementary embodiment, said anti-gelling agent comprises an alkyl chlorides, preferably chloroform. In yet another preferred embodiment, said anti-gelling agent comprises a silicon (IV) carboxylate, preferably silicon (IV) 2-ethylhexanoate.

In a preferred embodiment, the present invention provides a method according to the first aspect of the invention, whereby said anti-gelling agent is selected from the group comprising hydrochloric acid HCl, hydrobromic acid HBr, hydroiodic acid HI, neodymium (III) chloride NdCl₃, silicon tetrachloride SiCl₄ and/or Si (IV) 2-ethylhexanoate.

Preferably, said anti-gelling agent is hydrochloric acid HCl, neodymium (III) chloride NdCl₃, or silicon tetrachloride SiCl₄, or a combination of two or more of the aforementioned.

In a preferred embodiment, the present invention provides a method according to the first aspect of the invention, whereby step (a) is performed in the absence of an anti-gelling agent.

In an alternative preferred embodiment, the present invention provides a method according to the first aspect of the invention, whereby said anti-gelling agent is added to said neodymium (III) compound in step (a), and whereby said anti-gelling agent is selected from the group consisting of silicic acid (H₄SiO₄) and silicon (IV) esters.

In a preferred embodiment, said anti-gelling agent is a silicon (IV) carboxylate, preferably silicon (IV) 2-ethylhexanoate.

In a preferred embodiment, the present invention provides a method according to the first aspect of the invention, whereby the molar ratio of said anti-gelling agent to neodymium ranges from 0.05 to 0.45, preferably from 0.05 to 0.35, and more preferably from 0.05 to 0.30.

In a preferred embodiment, the molar ratio of the anti-gelling agent to neodymium ranges from 0.05 to 0.25, more preferably from 0.08 to 0.15, and most preferably is about 0.08, 0.10, 0.12, or 0.14, or any value there in between.

In a preferred embodiment, the present invention provides a method according to the first aspect of the invention, whereby said promoter present in step (a) is selected from:
water used in a molar ratio to neodymium ranging from 0.1 to 25;
chloroform used in a molar ratio to neodymium ranging from 0.1 to 25;
a mixture of water and chloroform, wherein the molar ratio of the mixture to neodymium ranges from 0.1 to 25.

In a preferred embodiment, said promotor is water, and the molar ratio of water to neodymium is between 0.1 and 10, and preferably between 0.1 and 5.

In a preferred embodiment, the present invention provides a method according to the first aspect of the invention, whereby the molar ratio of said promotor present in step (a) to neodymium ranges from 0.1 to 5.

In a preferred embodiment, said promotor is water, and the molar ratio of water to neodymium is between 0.1 and 2, more preferably said molar ratio is about 0.2, 0.4, 0.6, 0.8, 1.0, 1.2, 1.4, 1.6, 1.8 or 2.0 or any value there in between.

In a preferred embodiment, the present invention provides a method according to the first aspect of the invention, whereby after step (b), and more preferably after step (c), at least part of said solvent is removed by distillation. Preferably, the amount of solvent removed from the neodymium (III) alkyl phosphate solution is predetermined to arrive at a desired neodymium concentration in the solution, said solution comprising a residual amount of solvent.

In a preferred embodiment, the present invention provides a method according to the first aspect of the invention, whereby said neodymium (III) compound is reacted with said organophosphorus acid at a temperature of at least 50° C., preferably at a temperature of at least 60° C., and even more preferably at a temperature of least 65° C. Most preferably, said reaction is performed at reflux under atmospheric pressure.

Further, the method of the present invention allows producing a neodymium (III) alkyl phosphate solution without applying high shear rates. In a preferred embodiment, the present invention provides a method according to the first aspect of the invention, whereby said neodymium (III) compound is reacted with said organophosphorus acid in the presence of a promoter, thereby obtaining a neodymium (III) alkyl phosphate solution, at a shear rate of 200 s⁻¹ or less. Particularly on an industrial scale, it is of great interest to avoid high shear rates. Not only are high shear rates associated with a large energy input, but reactors usually have to be modified using additional equipment. In a further preferred embodiment, a nitrogen stream may be introduced into the reactor from below to ensure sufficient mixing.

In a further aspect, the present invention provides a neodymium (III) alkyl phosphate solution, characterized by a neodymium content ranging from 6% to 10% w/w, preferably from 6% to 8% w/w or even from 6.5% to 7.5% w/w, more preferably between 6.9% and 7.3% w/w, a chloride content ranges from 500 to 5000 ppm, preferably from 1000 and 3000 ppm, and more preferably from 1400 to 2300 ppm, a moisture content not exceeding 500 ppm, more preferably not exceeding 220 ppm and a free alkyl phosphate content ranging from 0 to 10% w/w, preferably from 2 to 7% w/w, and more preferably from 4.0 to 6.6% w/w.

In yet a further aspect, the present invention provides a use of a neodymium (III) alkyl phosphate solution obtained by the method according to the first aspect of the invention as a catalyst precursor for diene polymerization reactions. In a preferred embodiment, the neodymium (III) alkyl phosphate is neodymium (III) bis(2-ethylhexyl)phosphate and the free alkyl phosphate is bis(2-ethylhexyl) hydrogen phosphate.

### DETAILED DESCRIPTION OF THE INVENTION

### Examples

Neodymium (III) alkyl phosphate solutions were synthesized as explained in detail below and their parameters were characterized by the following techniques.

### Characterization Techniques

The weight contents of Nd and neodymium bis(2-ethylhexyl)phosphate (NdP) based on the total neodymium (III) alkyl phosphate solution were determined by complexometric titration with EDTA as a titrant.
The weight content of free DEHPA based on the total neodymium (III) alkyl phosphate solution was determined by potentiometric titration.
The amount of chlorine was determined by a precipitation titration with silvernitrate as titrant.
The amount of water was determined by the Karl Fischer method.
The viscosity of the neodymium (III) alkyl phosphate solutions was measured using a Physica MCR 51 rheometer from Anton Paar. If not indicated otherwise, the concentration of the solutions was adjusted to 45% w/w. The measurement temperature was 25° C. and the viscosity value was determined for a shear rate of 10 s⁻¹.

The inventors were able to scale up all the syntheses described below from laboratory scale to industrial scale. For this purpose, a reactor was used that has been designed for viscous products. The inner diameter of the reactor is 1775 mm, which results in nominal capacity of about 5 MT (ca. 6250 L). The reactor comprises two agitators turning in opposite directions. The outer agitator, which has an anchor and two blades of 1630 mm in diameter, provides 21 rpm with a motor of 15 kW, which results in a blade tip peripheral speed of 1.43 m/s. The inside agitator has three blades of 1300 mm in diameter that provides 20 rpm with a motor of 11 kW, which results in a blade tip peripheral speed of 1.36 m/s.

### Counterexample 1 [CE1]: Synthesis of neodymium bis(2-ethylhexyl)phosphate Solution According to U.S. Pat. No. 6,197,713

Neodymium oxide (20 g, 0.06 mol) was added to a 4-neck, 1 liter, round bottom flask fitted with a Dean-Stark trap, a condenser and a mechanical stirrer. The laboratory kit was flushed with nitrogen for 10 minutes. Then bis(2-ethylhexyl) hydrogen phosphate (97.5% pure) (122.65 g, 0.371 mol) was poured and rinsed by methylcyclohexane (560 ml), giving a slurry, to which 20 ml of water was added. The solution was heated up to 80° C. and refluxed until a milky, light violet solution was formed (after approx. 7 h). During the process viscosity of the reaction mixture increased, so the agitator speed had to be increased from 350 to 500 rpm. Water was then removed by azeotropic distillation. During azeotropic distillation the internal temperature was increased up to 100° C. As a result of azeotropic distillation a clear gel solution was obtained with the following parameters:

| DEHPA/Nd | | | | Free | | Viscosity |
|---|---|---|---|---|---|---|
| molar ratio | Nd | NdP | Cl | DEHPA | Water | at 25° C. |
| 3.12 | 3.19% | 24.54% | 0 | 1.90% | 140 | 475.1 |
| | w/w | w/w | ppm | w/w | ppm | dPa · s |

To the cooled gel solution 1.2 ml of anhydrous tin tetrachloride was added. Excess solvent was then evaporated to yield a final solution with following parameters:

| Sample | DEHPA/Nd | | | | Free | | Viscosity |
|---|---|---|---|---|---|---|---|
| ref. | molar ratio | Nd | NdP | Cl | DEHPA | Water | at 25° C. |
| CE1 | 3.12 | 7.0% | 53.8% | 4800 | 3.2% | 140 | 19.1 |
| | | w/w | w/w | ppm | w/w | ppm | dPa · s |

### Counterexample 2 [CE2]: Synthesis of neodymium bis(2-ethylhexyl)phosphate Solution According to U.S. Pat. No. 8,404,821

Neodymium oxide (20 g, 0.06 mol) was added to a 4-neck, 1 liter, round bottom flask fitted with a Dean-Stark trap, a condenser and a mechanical stirrer (500 rpm). The laboratory kit was flushed with nitrogen for 10 minutes. Then bis(2-ethylhexyl) hydrogen phosphate (97.5% pure) (135 g, 0.400 mol) was poured and rinsed by methylcyclohexane (780 ml), giving a slurry to which 6.8 ml of 1M hydrochloric acid was added. Under constant stirring the mixture was heated up to 80° C., maintained for 3 h at this temperature, and then cooled down. Further, as taught by U.S. Pat. No. 8,404,821 the resulting mixture was washed three times with water (20 g per each washing step) to remove residual hydrochloric acid. Each washing step involved stirring the mixture for 30 minutes followed by 30 minutes of separation by settling out. Only in the last washing step the separation by settling out lasted 12 h. After the last washing step the upper layer showed high viscosity. Water was then removed by azeotropic distillation. During azeotropic distillation the internal temperature was increased up to 100° C. As a result of azeotropic distillation a clear gel solution was obtained with the following parameters:

| Sample | DEHPA/Nd | | | | Free | | Viscosity |
|---|---|---|---|---|---|---|---|
| ref. | molar ratio | Nd | NdP | Cl | DEHPA | Water | at 25° C. |
| CE2 | 3.55 | 1.6% | 12.4% | 0 | 1.9% | 200 | 922 |
| | | w/w | w/w | ppm | w/w | ppm | dPa · s |

### Counterexample 3 [CE3]: Synthesis of neodymium bis(2-ethylhexyl)phosphate Solution According to U.S. Pat. No. 7,906,631

Neodymium oxide (20 g, 0.06 mol) was added to a 4-neck, 1 liter, round bottom flask fitted with a Dean-Stark trap, a condenser, and a mechanical stirrer (500 rpm). The laboratory kit was flushed with nitrogen for 10 minutes. Then bis(2-ethylhexyl) hydrogen phosphate (97.5% pure) (119.05 g, 0.36 mol) was poured and rinsed by methylcyclohexane (780 ml), giving a slurry, to which 1.65 g of 35% w/w hydrochloric acid. The slurry was agitated to result in a solution. A temperature of a reaction solution was raised up to 45° C. As the reaction solution become translucent while the reaction was continued at this temperature, the temperature of the reaction solution was then raised to 65° C. by gradually heating. Further, the reaction was continued at this temperature until the solution became transparent indicating the completion of the reaction. Further, water was removed by azeotropic distillation resulting in a final solution having a concentration about 20% w/w (the concentration was lower than in U.S. Pat. No. 7,906,631 because of lower amount of solvent evaporated during azeotropic distillation). As a result of azeotropic distillation a clear gel solution was obtained with the following parameters:

| Sample | DEHPA/Nd | | | | Free | | Viscosity |
|---|---|---|---|---|---|---|---|
| ref. | molar ratio | Nd | NdP | Cl | DEHPA | Water | at 25° C. |
| CE3 | 3.00 | 2.56% | 19.69% | 595 | 2.2% | 150 | 101.8 |
| | | w/w | w/w | ppm | w/w | ppm | dPa · s |

Due to extremely high product viscosity, it was impossible to obtain a solution having a concentration of at least 45% w/w.

### Example 1 [E1]: Synthesis of neodymium bis(2-ethylhexyl)phosphate Solution

Neodymium oxide (20 g, 0.06 mol) was added to a 4-neck, 1 liter, round bottom flask fitted with a Dean-Stark trap, a condenser and a mechanical stirrer. The laboratory kit was flushed with nitrogen for 10 minutes. Then bis(2-ethylhexyl) hydrogen phosphate (97.5% pure) (122.65 g, 0.371 mol) was poured and rinsed by methylcyclohexane (560 ml), giving a slurry, to which 20 ml of water was added. The solution was heated up to 80° C. and refluxed until a milky, lightly violet solution was formed (after approx. 7 h). During the process viscosity of the reaction mixture increased, so the agitator speed had to be increased from 350 to 500 rpm. Water was then removed by azeotropic distillation. During the azeotropic distillation the internal temperature was increased up to 100° C. As a result of azeotropic distillation a clear gel solution was obtained with the following parameters:

| DEHPA/Nd | | | | Free | | Viscosity |
|---|---|---|---|---|---|---|
| molar ratio | Nd | NdP | Cl | DEHPA | Water | at 25° C. |
| 3.12 | 3.19% | 24.54% | 0 | 1.90% | 140 | 475.1 |
| | w/w | w/w | ppm | w/w | ppm | dPa · s |

To the cooled gel solution 1.2 ml of anhydrous silicon tetrachloride was added, followed by removal of excessive solvent, resulting in highly concentrated stable violet clear solution with following parameters:

| Sample | DEHPA/Nd | | | | Free | | Viscosity |
|---|---|---|---|---|---|---|---|
| ref. | molar ratio | Nd | NdP | Cl | DEHPA | Water | at 25° C. |
| E1 | 3.12 | 6.68% | 51.38% | 5300 | 6.5% | 150 | 40.6 |
| | | w/w | w/w | ppm | w/w | ppm | dPa · s |

### Example 2 [E2]: Synthesis of neodymium bis(2-ethylhexyl)phosphate Solution

Neodymium oxide (20 g, 0.06 mol) was added to a 4-neck, 1 liter, round bottom flask fitted with a Dean-Stark trap, a condenser and a mechanical stirrer. The laboratory kit was flushed with nitrogen for 10 minutes. Then bis(2-ethylhexyl) hydrogen phosphate (97.5% pure) (122.65 g, 0.371 mol) was poured and rinsed by methylcyclohexane (560 ml), giving a slurry, to which water (20 ml) and tin (II) ethylhexanoate (3.3 ml, 0.01 mol) were added. The solution was heated up to 80° C. and refluxed until a milky, lightly violet solution was formed (after approx. 7 h). During the process viscosity of the reaction mixture increased, so the agitator speed had to be increased from 350 to 500 rpm. Once the reaction was terminated, water was removed by azeotropic distillation. During the azeotropic distillation the internal temperature was increased up to 100° C. After the distillation the water content was 170 ppm. As a result of azeotropic distillation excess solvent was removed, giving a stable violet slightly turbid solution with the following parameters:

| Sample | DEHPA/Nd | | | | Free | | Viscosity |
|---|---|---|---|---|---|---|---|
| ref. | molar ratio | Nd | NdP | Cl | DEHPA | Water | at 25° C. |
| E2 | 3.12 | 6.3% | 48.46% | 0 | 3.7% | 170 | 14.7 |
| | | w/w | w/w | ppm | w/w | ppm | dPa · s |

### Example 3 [E3]: Synthesis of neodymium bis(2-ethylhexyl)phosphate Solution

Neodymium oxide (20 g, 0.06 mol) was added to a 4-neck, 1 liter, round bottom flask fitted with a Dean-Stark trap, a condenser and a mechanical stirrer. The laboratory kit was flushed with nitrogen for 10 minutes. Then bis(2-ethylhexyl) hydrogen phosphate (97.5% pure) (122.65 g, 0.371 mol) was poured and rinsed by methylcyclohexane (560 ml), giving a slurry to which water (20 ml) and silicon (IV) 2-ethylhexanoate (6.0 g, 0.01 mol) were added.

The solution was heated up to 80° C. and refluxed until a milky, lightly violet solution was formed (after approx. 7 h). During the process no increase of viscosity of the reaction mixture was observed, but nevertheless the agitator speed was increased from 350 to 500 rpm. Once the reaction was terminated, water was removed by azeotropic distillation. At this stage gel formation was observed. 1.25 ml of 37% w/w of hydrochloric acid was added to the post-reaction mixture to decrease its viscosity. During the azeotropic distillation the internal temperature was increased up to 100° C. After the distillation the water content was 210 ppm. As a result of azeotropic distillation excess solvent was removed, giving a stable violet clear solution with the following parameters:

| Sample | DEHPA/Nd | | | | Free | | Viscosity |
|---|---|---|---|---|---|---|---|
| ref. | molar ratio | Nd | NdP | Cl | DEHPA | Water | at 25° C. |
| E3 | 3.12 | 7.11% | 54.69% | 1640 | 4.3% | 210 | 52.43 |
| | | w/w | w/w | ppm | w/w | ppm | dPa · s |

### Example 4 [E4]: Synthesis of neodymium bis(2-ethylhexyl)phosphate Solution

Neodymium oxide (20 g, 0.06 mol) was added to a 4-neck, 1 liter, round bottom flask fitted with a Dean-Stark trap, a condenser and a mechanical stirrer. The laboratory kit was flushed with nitrogen for 10 minutes. Then bis(2-ethylhexyl) hydrogen phosphate (97.5% pure) (122.65 g, 0.371 mol) was poured and rinsed by methylcyclohexane (560 ml), giving a slurry, to which 20 ml of water was added. The solution was heated up to 80° C. and refluxed until a milky, lightly violet solution was formed (after approx. 7 h). During the process viscosity of the reaction mixture increased, so the agitator speed had to be increased from 350 to 500 rpm. Once the reaction was terminated, the reaction mixture was cooled down. 1.25 ml of 37% w/w of hydrochloric acid was added to this mixture to decrease its viscosity. The solution was stirred for 30 min at temperature below 50° C., followed by water removal by azeotropic distillation. During the azeotropic distillation the internal temperature was increased up to 100° C. After the distillation the water content was 300 ppm. As a result of azeotropic distillation excess solvent was removed, giving a highly concentrated, stable violet clear solution with the following parameters:

| Sample | DEHPA/Nd | | | | Free | | Viscosity |
|---|---|---|---|---|---|---|---|
| reference | molar ratio | Nd | NdP | Cl | DEHPA | Water | at 25° C. |
| E4 | 3.12 | 6.8% | 52.6% | 1600 | 4.0% | 300 | 54.99 |
| | | w/w | w/w | ppm | w/w | ppm | dPa · s |

### Example 5 [E5]: Synthesis of neodymium bis(2-ethylhexyl)phosphate Solution

Neodymium oxide (20 g, 0.06 mol) was added to a 4-neck, 1 liter, round bottom flask fitted with a Dean-Stark trap, a condenser and a mechanical stirrer. The laboratory kit was flushed with nitrogen for 10 minutes. Then bis(2-ethylhexyl) hydrogen phosphate (97.5% pure) (122.65 g, 0.371 mol) was poured and rinsed by methylcyclohexane (560 ml), giving a slurry, to which 20 ml of water was added. The solution was heated up to 80° C. and refluxed until a milky, lightly violet solution was formed (after approx. 7 h). During the process viscosity of the reaction mixture increased, so the agitator speed was increased from 350 to 500 rpm. Once the reaction was terminated, the reaction mixture was cooled down. 1.2 g of NdCl₃ was then added to this mixture to decrease its viscosity. The solution was stirred for 30 min at temperature below 50° C., followed by water removal by azeotropic distillation. During the azeotropic distillation the internal temperature was increased up to 100° C. After the distillation the water content was 300 ppm. As a result of azeotropic distillation excess solvent was removed, giving a highly concentrated, stable violet clear solution with the following parameters:

| Sample | DEHPA/Nd | | | | Free | | Viscosity |
|---|---|---|---|---|---|---|---|
| ref. | molar ratio | Nd | NdP | Cl | DEHPA | Water | at 25° C. |
| E5 | 3.12 | 6.9% | 53.0% | 1780 | 2.3% | 300 | 45.2 |
| | | w/w | w/w | ppm | w/w | ppm | dPa · s |

### Example 6 [E6]: Synthesis of neodymium bis(2-ethylhexyl)phosphate Solution

Neodymium oxide (20 g, 0.06 mol) was added to a 4-neck, 1 liter, round bottom flask fitted with a Dean-Stark trap, a condenser and a mechanical stirrer. The laboratory kit was flushed with nitrogen for 10 minutes. Then bis(2-ethylhexyl) hydrogen phosphate (97.5% pure) (122.65 g, 0.371 mol) was poured and rinsed by methylcyclohexane (560 ml), giving a slurry, to which 90 ml of chloroform was added. The solution was heated up to 80° C. and refluxed until a milky, lightly violet solution was formed (after approx. 2 h). During the process viscosity of the reaction mixture increased, so the agitator speed was increased from 350 to 500 rpm. Water and chloroform were then removed by azeotropic distillation. During the azeotropic distillation the internal temperature was increased up to 100° C. After the azeotropic distillation the reaction mixture was cooled down. 1.25 ml of 37% w/w of hydrochloric acid was added to this mixture to decrease its viscosity. The solution was stirred for 30 min at temperature below 50° C., followed by water removal by azeotropic distillation. During the azeotropic distillation the internal temperature was increased up to 100° C. After the distillation the water content was 160 ppm. As a result of azeotropic distillation excess solvent was removed, giving a highly concentrated, stable violet clear solution with the following parameters:

| Sample | DEHPA/Nd | | | | Free | | Viscosity |
|---|---|---|---|---|---|---|---|
| ref. | molar ratio | Nd | NdP | Cl | DEHPA | Water | at 25° C. |
| E6 | 3.12 | 7.0% | 53.85% | 2170 | 4.75% | 160 | 65.5 |
| | | w/w | w/w | ppm | w/w | ppm | dPa · s |

### Example 7: Preparation and Activity Evaluation of Catalyst Systems

Catalysts systems were prepared using neodymium bis(2-ethylhexyl)phosphate solutions of Comparative Examples 1-3 and Examples 1-6 according to the procedure and under the conditions described in detail in U.S. Pat. No. 9,090,637, which is hereby included by reference in its entirety.

Catalytic activity of all nine catalyst systems obtained was measured by conversion rate in a polymerization reaction, also performed according to the conditions disclosed in detail in U.S. Pat. No. 9,090,637. Activity test results are provided in Table 1 below.

TABLE 1
Activity test results of the
prepared catalyst systems

| Starting | | % BD |
|---|---|---|
| solution | | Conversion |
| sample | | after |
| reference | Catalyst name | 30 min |
| CE1 | Catalyst 1 | 73 |
| CE2 | Catalyst 2 | 84 |
| CE3 | Catalyst 3 | 94 |
| E1 | Catalyst 4 | 100 |
| E2 | Catalyst 5 | 86 |
| E3 | Catalyst 6 | 100 |
| E4 | Catalyst 7 | 100 |
| E5 | Catalyst 8 | 100 |
| E6 | Catalyst 9 | 100 |

Catalysts 1 and 5 showed poor conversion, most likely due to negative impact of residual tin. Catalyst 2 had a form of highly viscous solution, negatively affecting its activity. Only the catalysts, which passed the activity test (by reaching 100% conversion in 30 minutes), i.e. Catalysts 4, 6, 7, 8 and 9 were further tested in NdBR polymerization.

### Examples 1B-6B: Batch Coordination Polymerization of 1,3-Butadien Using Nd-Containing Catalysts

The Catalysts 4-9 obtained in Example 7 above were used in polymerization of 1,3-butadiene.

General principles and procedure of 1,3-butadiene homopolymerization using Nd-based catalytic systems are described in by Friebe L., Nuyken O. and Obrecht W. in “A Comparison of Neodymium Versatate, Neodymium Neopentanolate and Neodymium Bis(2-ethylhexyl)phosphate in Ternary Ziegler Type Catalyst Systems With Regard to their Impact on the Polymerization of 1,3-Butadiene”, in Journal of Macromolecular Science, Part A: Pure and Applied Chemistry, (2005), 42, 7, 839-851, as well as by Friebe, L., Nuyken, O., Windisch, H., and Obrecht, W. in “Polymerization of 1,3-butadiene initiated by neodymium versatate/diisobutylaluminum hydride/ethylaluminum sesquichloride: Kinetics and conclusions about the reaction mechanism”. in Macromol. Chem. Phys., (2002), 203, 8, 1055-1064.

### Polymerization

The batch polymerization of 1,3-butadiene was realized according to the following procedure:

A 20-liter reactor was loaded with dry 1,3-butadiene and dry solvent (cyclohexane) and heated to 80° C. Then, diisobutylaluminum hydride (DIBAH) (0.1 M/L solution in cyclohexane) was added. Polymerization was started by addition of a catalyst solution. The reaction mixture was heated and continuously stirred during the entire process. The reaction mixture temperature was maintained between 6° and 90° C. The polymerization was terminated using nitrogen-purged isopropyl alcohol. The resulting polymer solution was rapidly stabilized by the addition of 2-methyl-4,6-bis(octylsulfanylmethyl) phenol (at 1.0 phr polymer).

The polymer solution was subsequently transferred to a stripper. The reactor was flushed with portions of fresh cyclohexane and its content was also transferred to the stripper. Distilled water, in an amount twice the total mass of polymer solution, as well as pH regulator and soap were added to the polymer solution, and the stripper contents were then treated with steam. Steam-stripping was continued until the entire amount of cyclohexane was removed and rubber crumbs were obtained. Then, the rubber crumbs were removed from the stripper, cooled to room temperature, milled and dried in a hot air stream.

### Molecular Weight Determination

Gel permeation chromatography was performed by means of PSS Polymer Standards Service multiple columns (with guard column) using THE as the eluent and for sample preparation. Multi-angle laser light scattering measurements were carried out using a Wyatt Technologies Dawn Heleos II light scattering detector, DAD (PDA) Agilent 1260 Infinity UV-VIS detector and Agilent 1260 Infinity refractive index detector.

Determination of Vinyl Content, cis-1,4 content, trans-1,4 Content (%)

The microstructure of butadiene rubber was determined by IR spectroscopy (Thermo Scientific Nicolet Is10). The following peaks were used for quantitative determination of the poly(butadiene) microstructure: 735 cm⁻¹ (δ(cis-R—CH—CR—H),→cis-1,4, ε=0.192), 912 cm⁻¹ (δ(R—CH—CH—H),→vinyl (1,2), ε=1.0), 965 cm⁻¹ (δ(trans-R—CH—CR—H),→trans-1,4, ε=0.769). The methodology of this procedure was as described in detail by M. Kraft, Struktur und Absorptionsspektroskopie der Kunststoffe, VCH, Weinheim 1973, p. 93 and by E. O. Schmalz, W. Kimmer, in Z. Anal. Chem. 1961, 181, 229.

### Glass Transition Temperature (° C.)

Glass transition temperature, Tg, was determined according to PN-EN ISO 11357-1:2009

### Mooney Viscosity (ML(1+4)/100° C.)

Mooney Viscosity (MV) was determined according to ASTM D 1646-07, using a large rotor under the conditions of preheating=1 minute, rotor operating time=4 minutes, and temperature=100° C.

The reaction conditions as well as characteristics of the resulting polymers were presented in Table 2 below.

TABLE 2
Batch polymerization reaction conditions and characteristics of resulting polymers

| | | Reaction conditions | | | | | | | | | | | | | |
|---|---|---|---|---|---|---|---|---|---|---|---|---|---|---|---|
| | | | Cyclo- | 1,3- | | | | GPC results | | | FTIR results [%] | | | DSC | |
| | | Tᵢₙᵢₜ | hexane | butadiene | | | | Mn | Mw | | | 1,4- | 1,4- | results | MV |
| Ex. | Catalyst | [° C.] | [g] | [g] | n_{M}/n_{Nd} | n_{Cl}/ n_{Nd} | n_{DIBAH}/n_{Nd} | [kg/mol] | [kg/mol] | Mw/Mn | Vinyl | cis | trans | Tg, ° C. | [1 + 4] |
| 1B | 4 | 60 | 12000 | 1500 | 9250 | 2 | 8 | 234.7 | 449.2 | 1.91 | 1.17 | 96.92 | 1.91 | −108.6 | 43.0 |
| 2B | 5 | 60 | 12000 | 1500 | 9250 | 2 | 8 | 220.6 | 414.0 | 1.88 | 1.01 | 97.14 | 1.85 | −108.9 | 43.2 |
| 3B | 6 | 60 | 12000 | 1500 | 9250 | 2 | 8 | 227.0 | 415.7 | 1.83 | 0.8 | 97.60 | 1.6 | −108.6 | 45.0 |
| 4B | 7 | 60 | 12000 | 1500 | 9250 | 2 | 8 | 236.8 | 443.6 | 1.87 | 1.02 | 97.33 | 1.65 | −107.2 | 47.5 |
| 5B | 8 | 60 | 12000 | 1500 | 9250 | 2 | 8 | 257.1 | 412.4 | 1.60 | 0.85 | 97.15 | 2.00 | −106.8 | 49.9 |
| 6B | 9 | 60 | 12000 | 1500 | 9250 | 2 | 8 | 196.9 | 303.8 | 1.54 | 0.98 | 96.9 | 2.12 | −105.2 | 39.2 |

n_{M}/n_{Nd}—molar ratio of monomer to Nd;
n_{Cl}/n_{Nd}—molar ratio of chloride to Nd;
n_{DIBAH}/n_{Nd}—molar ratio of DIBAH to Nd

### Examples 1C-3C: Continuous Coordination Polymerization of 1,3-Butadien Using Nd-Containing Catalysts

Since in batch processes of Examples 1B-6B all polymer samples showed nearly the same properties and very similar results in application test, a continuous polymerization on a pilot scale was performed only using the Catalyst 7. The continuous polymerization of 1,3-butadiene was realized according to the following procedure:

The butadiene homopolymer was prepared in a series of two reactors, having volume of 10 L (first reactor) and 20 L (second reactor), respectively. Each reactor was equipped with a paddle stirrer. The agitation speed was 150-200 rpm and filling factor was maintained at the level of 50%-90%. Cyclohexane, 1,3-butadiene, DIBAH solution and the catalyst solution were dosed into the first reactor. The temperature in each of the reactors was between 80° C. and 100° C. At the outlet of the second reactor isopropanol was added as a reaction stopper (1.5 phr), followed by addition of 2-methyl-4,6-bis(octylsulfanylmethyl) phenol (in form of hexane solution) as an antioxidant (0.6 phr). The polymers were recovered by a conventional recovery operation of solvent steam stripping and then dried for 12 h in a vacuum dryer.

Characterization of the resulting rubber was performed by the procedures as described for Examples 1B-6B above.

The reaction conditions as well as characteristics of the resulting polymers were presented in Table 3 below.

TABLE 3
Continuous polymerization reaction conditions and characteristics of resulting polymers

| | Reaction conditions | | | | | | | | | | | | | | |
|---|---|---|---|---|---|---|---|---|---|---|---|---|---|---|---|
| | | | Cyclo- | 1,3- | | | | GPC results | | | FTIR results [%] | | | DSC | |
| | T_{R1} | T_{R2} | hexane | butadiene | | | | Mn | Mw | | | 1,4- | 1,4- | results | MV |
| Ex. | [° C.] | [° C.] | [kg/h] | [kg/h] | n_{M}/n_{Nd} | n_{Cl}/ n_{Nd} | n_{DIBAH}/n_{Nd} | [kg/mol] | [kg/mol] | Mw/Mn | Vinyl | cis | trans | Tg, ° C. | [1 + 4] |
| 1C | 85 | 90 | 6.51 | 0.49 | 11200 | 2.65 | 6.66 | 23500 | 393100 | 1.84 | 1.26 | 96.41 | 2.33 | −107.14 | 42.7 |
| 2C | 85 | 90 | 6.51 | 0.49 | 11200 | 2.65 | 8.48 | 205700 | 381900 | 1.86 | 1.06 | 96.77 | 2.16 | −107.35 | 37.5 |
| 3C | 85 | 90 | 6.51 | 0.49 | 11200 | 2.65 | 8.48 | 202700 | 376600 | 1.86 | 1.02 | 96.86 | 2.11 | −106.60 | 38.1 |

n_{M}/n_{Nd}—molar ratio of monomer to Nd;
n_{Cl}/n_{Nd}—molar ratio of chloride to Nd;
n_{DIBAH}/n_{Nd}—molar ratio of DIBAH to Nd

### Example 8: Vulcanization of Butadiene Rubbers Obtained in the Batch Process

The rubbers obtained in Examples 1B, 2B, 3B, 4B, 5B and 6B were compounded according to the compounding recipe shown in Table 4 below. The compounding of the solution styrene-butadiene rubber, fillers, and rubber additives was performed in a Banbury type internal mixer (350E Brabender GmbH& Co. KG) and on a lab sized two-roll mill. The rubber compounds were mixed at two different stages and the final pass was completed on a two-roll mill.

TABLE 4
Compounding recipe of rubber composition
obtained in the batch process

| | | Mixing |
|---|---|---|
| Component | phr | stage |
| SBR | 71.5 | 1 |
| Polybutadiene rubber obtained in | 48 | 1 |
| one of the Examples 1B-6B | | |
| Silica | 80 | 1 |
| Carbon Black | 5 | 2 |
| Stearic acid | 2 | 1 |
| Zinc oxide | 2 | 1 |
| TDAE (Treated Distillate Aromatic | 8.5 | 1 |
| Extracted) oil extender | | |
| 6PPD (N-(1,3-dimethylbutyl)-N'- | 2 | 1 |
| phenyl-1,4-benzenediamine) | | |
| Phenolic antioxidant | 2 | 1 |
| Microcrystalline paraffin wax | 2 | 1 |
| Bis[3-(triethoxysilyl)propyl]tetrasulfide | 6.4 | 1 |
| N-tert-butyl-2-benzothiazole sulfenamide | 1.7 | 3 |
| 1,3-Diphenylguanidine | 2 | 3 |
| Sulphur | 1.5 | 3 |

The first stage (stage 1) involved mixing the rubbers with oil, silica, silane coupling agent, 6PPD and activators in several steps. After that the compounded mixture was allowed to sit for 24 hours. The second stage (stage 2) involved mixing aimed to further improve the distribution of silica along with addition of carbon black. The rubber compound was allowed then to condition for four hours before the final pass, which was performed on a two-roll mill.

At the next step cure packages were added to the rubber compounds. Rheological measurements of compounds were performed after the addition of cure packages, but before the vulcanization process. The following parameters of green (unvulcanized) compounds were measured:

### Vulcanization Characteristics

Vulcanization characteristics was determined according to ASTM D6204 using RPA 2000 Alpha Technologies rubber processing analyzer, operating time=30 minutes and temperature=170° C.

Following the addition of cure packages, each rubber compound was vulcanized at 170° C., for T_{95×1.5} minutes (based on RPA results), to obtain a vulcanizate. For each vulcanized rubber compound the following parameters were measured:

Tire predictors (tan δ and G* at 60° C., tan § at 0° C., tan δ at −10° C., G′ and J″ at 30° C., G′ at −20° C.))

A vulcanized rubber compound test sample was measured using a dynamic mechanical analyzer (DMA GABO EPLEXOR) in single shear mode under the conditions of dynamic strain=2%, frequency=10 Hz, in the temperature ranging from −80 to 65° C., with a heating rate of 2.5 K/min.

### Rebound Resilience

Rebound resilience of test vulcanized rubber samples was determined according to ISO 4662.

### Silica Dispersion

Silica dispersion was determined according to ISO 1134 C, D, E; ASTM D7723, using disperGRADER Alpha Technologies

The dynamic and mechanical properties of vulcanized rubbers originating from the batch polymerization process are shown in Table 5 below.

TABLE 5
Dynamic and mechanic properties of vulcanized rubbers originating from the batch polymerization process

| | | | | | Rebound | Rebound | | | | |
|---|---|---|---|---|---|---|---|---|---|---|
| | | | E′ | Hardness | resilience | resilience | | DIN | Tensile | Elongation |
| | tan δ | tan δ, | (30° C.) | (23° C.), | (23° C.), | (70° C.), | Dispersion | Abrasion | strength | at break |
| Ex. | (60° C.) | (0° C.) | [MPa] | [°ShA] | [%] | [%] | [%] | [mm³] | [MPa] | [%] |
| REF | 0.143 | 0.310 | 13.6 | 66 | 42 | 63 | 92 | 66 | 19 | 423 |
| 1B | 0.145 | 0.300 | 14.1 | 65 | 42 | 61 | 89 | 57 | 18.1 | 422 |
| 2B | 0.140 | 0.300 | 13.9 | 66 | 42 | 62 | 85 | 58 | 17.6 | 402 |
| 3B | 0.138 | 0.290 | 12.9 | 66 | 45 | 64 | 86 | 60 | 18.3 | 432 |
| 4B | 0.144 | 0.310 | 13.9 | 66 | 42 | 64 | 91 | 63 | 17.3 | 400 |
| 5B | 0.141 | 0.300 | 13.4 | 65 | 46 | 66 | 87 | 65 | 18.6 | 434 |
| 6B | 0.141 | 0.300 | 13.5 | 65 | 43 | 65 | 90 | 63 | 17.4 | 407 |

REF—reference butadiene rubber produced by polymerization in Nd catalyst-based solution [SYNTECA ® 44 by Synthos Group]
tan δ (60° C.)—rolling resistance predictor
tan δ, (0° C.)—wet Grip predictor
E′ (30° C.)—dry handling predictor

### Example 9: Vulcanization of Butadiene Rubbers Obtained in the Continuous Process

The rubbers obtained in Examples 1C, 2C and 3C were compounded according to the compounding recipe shown in Table 6 below. The compounding of the solution styrene-butadiene rubber, fillers, and rubber additives was performed in a Farrel type internal mixer (Mixer Farrel BR+1600) and on a lab-sized two-roll mill. The rubber compounds were mixed at three different stages, the first two on internal mixer and the third one (final pass) on a two roll mill.

TABLE 6
Compounding recipe of rubber composition
obtained in the continuous process

| | | Mixing |
|---|---|---|
| Component | phr | stage |
| SBR | 75.1 | 1 |
| Polybutadiene rubber | 48 | 1 |
| Silica | 80 | 1 |
| Carbon Black | 5 | 2 |
| Stearic acid | 2 | 1 |
| Zinc oxide | 2 | 1 |
| TDAE (Treated Distillate Aromatic | 8.5 | 1 |
| Extracted) oil extender | | |
| 6PPD (N-(1,3-dimethylbutyl)-N'- | 2 | 1 |
| phenyl-1,4-benzenediamine) | | |
| Phenolic antioxidant | 2 | 1 |
| Microcrystalline paraffin wax | 2 | 1 |
| Bis[3-(triethoxysilyl)propyl]tetrasulfide | 6.4 | 1 |
| N-tert-butyl-2-benzothiazole sulfenamide | 1.6 | 3 |
| 1,3-Diphenylguanidine | 2 | 3 |
| Sulphur | 1.5 | 3 |

The first stage (stage 1) involved mixing the rubbers with oil, silica, silane coupling agent, 6PPD and activators in several steps. After that the compounded mixture was allowed to sit for 24 hours. The second stage (stage 2) involved mixing aimed to further improve the distribution of silica along with addition of carbon black. The rubber compound was allowed then to condition for four hours before the final pass, which was performed on a two-roll mill. At the next step cure packages were added to the rubber compounds. Rheological measurements of compounds were performed after the addition of cure packages, but before the vulcanization process. These measurements involved determination of vulcanization characteristics and Payne effect, performed according to the procedures already indicated in Example 8 above.

Following the addition of cure packages, each rubber compound was vulcanized at 170° C., for T_{95×1.5} minutes (based on RPA results), to obtain a vulcanizate. For each vulcanized rubber compound the same parameters were measured as indicated in Example 8 above, i.e. tire predictors, rebound resilience, reinforcement factor and silica dispersion.

The only difference is that in case of tire predictors measurements another type of dynamic mechanical analyzer was used, namely DMA 450+ MetraviB.

The dynamic and mechanical properties of vulcanized rubbers originating from the continuous polymerization process are shown in Table 7 below.

TABLE 7
Dynamic and mechanic properties of vulcanized rubbers originating from the continuous polymerization process

| | | | | | Rebound | Rebound | | | | |
|---|---|---|---|---|---|---|---|---|---|---|
| | | | G′ | Hardness | resilience | resilience | | DIN | Tensile | Elongation |
| | tan δ | tan δ, | (30° C.) | (23° C.), | (23° C.), | (70° C.), | Dispersion | Abrasion | strength | at break |
| Ex. | (60° C.) | (0° C.) | [MPa] | [°ShA] | [%] | [%] | [%] | [mm³] | [MPa] | [%] |
| REF | 0.188 | 0.419 | 4.98E+06 | 65 | 43 | 64 | 85 | 61 | 18.1 | 408 |
| 1C | 0.191 | 0.433 | 5.18E+06 | 67 | 42 | 63 | 82 | 63 | 17.2 | 393 |
| 2C | 0.189 | 0.423 | 5.57E+06 | 66 | 42 | 63 | 83 | 65 | 18.4 | 408 |
| 3C | 0.176 | 0.411 | 5.21E+06 | 66 | 42 | 63 | 78 | 66 | 18.1 | 399 |

REF—reference butadiene rubber produced by polymerization in Nd catalyst-based solution [SYNTECA ® 44 by Synthos Group]
tan δ (60° C.)—rolling resistance predictor (the lower the better)
tan δ, (0° C.)—wet Grip predictor
G′ (30° C.)—dry handling predictor

The rubbers obtained of Examples 1B-6B (batch polymerization) and 1C-3C (continuous polymerization) were subjected to vulcanization in Example 8 and 9 respectively. Obtained vulcanizates were compared to each other and to a reference butadiene rubber REF [commercial grade SYNTECA® 44 by Synthos Group]. Results were presented in Table 5 and 7, respectively.

In each case, tire predictors obtained from DMA, such as rolling resistance, dry handling, and wet grip are very similar to the commercial grade SYNTECA® 44. Mechanical properties are very similar as well. The slightly differences in obtained values coming from different Mooney viscosity of rubbers and from nature of applied polymerization method batch vs continuous process, pilot vs industrial scale.

While certain representative embodiments and details have been shown for the purpose of illustrating the subject invention, it will be apparent to those skilled in this art that various changes and modifications can be made therein without departing from the scope of the subject invention, which scope is defined by the following claims.

1. A method for producing a neodymium (III) alkyl phosphate solution, said method comprising the steps of:
(a) reacting a neodymium (III) compound with an organophosphorous acid in a solvent in the presence of a promoter, thereby obtaining a neodymium (III) alkyl phosphate solution;
(b) adding an anti-gelling agent to the neodymium (III) alkyl phosphate solution obtained in step (a); and
(c) removing water formed and/or added during step (a) from the obtained neodymium (III) alkyl phosphate solution, thereby obtaining a solution comprising neodymium (III) alkyl phosphate.

2. The method according to claim 1, whereby steps (a), (b) and (c) are performed sequentially.

3. The method according to claim 1, whereby water is removed in step (c) until a neodymium concentration of at least 3 wt. %, relative to the total weight of the neodymium (III) alkyl phosphate solution, is achieved.

4. The method according to claim 1, whereby said neodymium (III) compound is selected from the group consisting of neodymium (III) oxide, neodymium (III) hydroxide, neodymium (III) carbonate, and hydrates thereof.

5. The method according to claim 1, whereby the organophosphorous acid is selected from the group consisting of phosphoric acid diesters of formula (RO)(R′O)PO(OH); phosphoric acid monoesters of formula (RO)P(O)(OH)₂; phosphonates of formula (RO)R′P(O)(OH) or RP(O)(OH)₂; phosphinates R(R′)P(O)OH or R(H)P(O)OH; and mixtures of two or more of the aforementioned, wherein each of R and R′, if present, independently denotes an n-butyl, isobutyl, pentyl, amyl, isopentyl, 2,2-dimethylhexyl, 2-ethylhexyl, 1-ethylhexyl, tolyl, nonylphenoxy radical.

6. The method according to claim 5, whereby the organophosphorous acid is bis(2-ethylhexyl) hydrogen phosphate.

7. The method according to claim 6, whereby the molar ratio of bis(2-ethylhexyl) hydrogen phosphate to neodymium ranges from 3.00 to 3.34.

8. The method according to claim 1, whereby said solvent is a hydrocarbon solvent.

9. The method according to claim 1, whereby said anti-gelling agent is a non-tin-based anti-gelling agent.

10. The method according to claim 1, whereby said anti-gelling agent comprises one or more compounds selected from the group consisting of:
mineral acids selected from the group consisting of perchloric acid HClO₄, chloric acid HClO₃, chlorous acid HClO₂, hydrochloric acid HCl, bromic acid HBrO₃, hydrobromic acid HBr, iodic acid HIO₃, periodic acid HIO₄, orthoperiodic acid H₅IO₆, hydroiodic acid HI, nitric acid HNO₃, peroxonitric acid HNO₄ and silicic acid H₄SiO₄;
organic acids selected from the group consisting of: trichloroacetic acid CCl₃—COOH), dichloroacetic acid CCl₂H—COOH and trifluoroacetic acid CF₃COOH;
lanthanide halides, lanthanide nitrates, as well as hydrates thereof;
silicon (IV) halides;
alkyl halides; and
silicon (IV) esters.

11. The method according to claim 10, whereby said anti-gelling agent is selected from the group comprising hydrochloric acid HCl, hydrobromic acid HBr, hydroiodic acid HI, neodymium (III) chloride NdCl₃, silicon tetrachloride SiCl₄ and/or silicon (IV) 2-ethylhexanoate.

12. The method according to claim 10, whereby step (a) is performed in the absence of an anti-gelling agent.

13. The method according to claim 10, whereby said anti-gelling agent is added to said neodymium (III) compound in step (a), and whereby said anti-gelling agent is selected from the group consisting of silicic acid (H₄SiO₄) and silicon (IV) esters.

14. The method according to claim 1, whereby the molar ratio of said anti-gelling agent to neodymium ranges from 0.05 to 0.45.

15. The method according to claim 1, whereby said promoter present in step (a) is selected from:
water used in a molar ratio to neodymium ranging from 0.1 to 25;
chloroform used in a molar ratio to neodymium ranging from 0.1 to 25
a mixture of water and chloroform, wherein the molar ratio of the mixture to neodymium ranges from 0.1 to 25.

16. The method according to claim 15, whereby the molar ratio of said promoter present in step (a) to neodymium ranges from 0.1 to 5.

17. The method according to claim 1, whereby said neodymium (III) compound is reacted with said organophosphorus acid at a temperature of at least 50° C.

18. A neodymium (III) alkyl phosphate solution obtained by the method according to claim 1.

19. Use of a neodymium (III) alkyl phosphate solution obtained by a method according to claim 1 as a catalyst precursor for diene polymerization.
